(19) United States
(12) Patent Application Publication
(10) Pub. No.: US 2012/0290119 A1
(43) Pub. Date: Nov. 15, 2012

(54) GARMENT PATTERN REPOSITORY AND CUTTER SYSTEM AND METHODS

(76) Inventor: Jeffrey E. Gillette, Midway, UT (US)

(21) Appl. No.: 13/471,031

(22) Filed: May 14, 2012

Related U.S. Application Data
(60) Provisional application No. 61/486,076, filed on May 13, 2011.

(51) Int. Cl. G06F 19/00

(52) U.S. Cl. 700/132

(57) ABSTRACT

A method for storing and accessing a garment pattern including uploading digital representations of one or more garment patterns to a network accessible file repository and accessing the file repository via a network connection associated with a personal computing device. The digital representation of the garment pattern is communicated from the personal computing device to a cutter. The cutter accesses the garment pattern to cut a portion of material according to the garment pattern. The cutter is configured to cut paper and the method further comprises cutting the paper to form a garment pattern. The garment pattern may be attached to fabric that is then cut along a perimeter of the garment pattern. The cutter may also be configured to cut fabric wherein the fabric is cut to form portions of a garment corresponding with the one or more garment patterns.

### CROSS-REFERENCE TO RELATED APPLICATIONS

This application claims the benefit of U.S. Provisional Application No. 61/486,076, filed May 13, 2011, the disclosure of which is hereby incorporated by reference in its entirety.

### FIELD

The present system and methods relate to a system and method for cutting fabric according to a digitized pattern. More specifically, the present system and methods detail an electronic pattern repository system and an associated cutter that can access and implement the electronic pattern.

### BACKGROUND

Patterns used to make clothing have historically come in a paper form. These patterns are printed using large printing presses and dated printing methodology. Once the pattern was acquired, the seamstress took the paper pattern and attached it to the fabric and used a pair of scissors to cut the fabric around a perimeter of the pattern.

Historically, pattern creators produced seasonal catalogues that contained information about new pre-printed patterns. These catalogs, along with a selected inventory of pre-printed patterns were available in fabric stores. Fabric stores retained several seasons of catalogues. When a seamstress wanted to create an item of clothing they would go to the pattern store and select the desired pattern from the catalog. If the store had the pre-printed pattern, the seamstress could purchase it or, if they didn't have the pattern, they would order it.

With the advent of personal printing technologies, a significant number of pattern creators have converted patterns to a digital format that can be downloaded from a web site and printed on a home printer. The printed pattern is then assembled into a format similar to the pre-printed format. The digital format most commonly used is .pdf.

With digital, or electronic, patterns, the process of finding a pattern has changed. Now, rather than going to a fabric store to find a pattern, the seamstress has the option of going to the pattern creator's website. On the website, the seamstress can see online versions of the pattern catalogs. Once they find a pattern that they like, they can go through a process of downloading a digital representation of the pattern. They can then print the pattern on their local printer and assemble it into a format similar to the pre-printed format.

The traditional pre-printed patterns generally come in various sizes. Within a size there are two or three sub sizes that a seamstress can use to customize the pattern for their needs. The new digital patterns continue to use the same two size format, requiring the seamstress to adjust the size of the pattern manually.

Each pattern creator, along with fabric and embellishment vendor, has had their own supply channels. Even as pattern creators have moved to a digital system, they each have retained their own channel. This results in the seamstress being forced go to multiple websites and physical locations to find, coordinate and purchase patterns and materials for a single garment. With the introduction of downloadable patterns, the options, processes and technologies have increased the complexity of finding a desired pattern, not simplified it.

Although progress has been made in making patterns more readily available via the internet, there is still a need to simplify the process of locating patterns, sizing the patterns, identifying suitable materials, and cutting the material to match the correctly sized pattern.

### SUMMARY

In one of many possible embodiments, the present exemplary system and method includes a clothes making process that is based on a digital repository of patterns that are interactively modifiable. The patterns are downloadable and can be printed or transferred to an electronic cutter.

Provided herein is a method for storing and accessing a garment pattern. In an embodiment, the method includes uploading digital representations of one or more garment patterns to a network accessible file repository and accessing the file repository via a network connection associated with a personal computing device to download the digital representation of the one or more garment patterns. The digital representation of the one or more garment patterns is communicated from the personal computing device to a cutter. The cutter accesses the one or more garment patterns to cut a portion of material according to the specifications of the one or more garment patterns. In one aspect of the technology described herein, the cutter is configured to cut paper and the method further comprises cutting the paper to form a garment pattern. The garment pattern may then be attached to fabric that is then cut along a perimeter of the garment pattern.

In another aspect of the present technology the cutter is configured to cut fabric and the method further comprises cutting the fabric to directly form portions of a garment corresponding with the one or more garment patterns. The garment may be assembled by joining the portions together.

In yet another aspect of the technology, the method may further comprise entering parameters to describe the size of a garment, wherein the parameters are selected from the group consisting of size, waist measurement, inseam measurement, height, weight, and chest circumference, for example. The garment patterns are adjusted or scaled based on the parameters.

Also provided herein is a garment pattern repository and cutter system. In an embodiment, the system includes a garment pattern file repository stored on a network server. A web interface is associated with the garment pattern file repository and a personal computing device is interconnected with the server to facilitate interaction with the garment pattern file repository via the web interface. The web interface may also be stored on the network server. A cutter is interconnected with the personal computing device, wherein the cutter is operative to cut a portion of material according to a garment pattern selected from the garment pattern repository. The personal computing device may be interconnected with the server via the internet and may be one of a tablet computer, a laptop computer, a desktop computer, and/or a smart phone, for example. In an additional aspect of the technology, the system further comprises a pattern customization module that is operative to adjust the size of the garment pattern based on parameters received from the personal computing device.

In another embodiment, the garment pattern repository and cutter system includes a garment pattern file repository stored on a network server. A web interface is associated with the garment pattern file repository and a personal computing device is interconnected with the server via the internet, such that it may facilitate interaction with the garment pattern file repository via the web interface. A cutter is interconnected with the personal computing device, wherein the cutter is operative to cut fabric into portions of a garment corresponding to a garment pattern selected from the garment pattern repository. The system also includes a pattern customization module that is operative to adjust the size of the garment pattern based on parameters received from the personal computing device.

These and other aspects of the technology and its various embodiments will be apparent after consideration of the Detailed Description and Figures herein. It is to be understood, however, that the scope of the present exemplary system and method shall be determined by the claims as issued and not by whether given subject matter addresses any or all issues noted in the background or includes any features or aspects recited in this summary.

### BRIEF DESCRIPTION OF THE DRAWINGS

The accompanying drawings illustrate various embodiments of the present system and method and are a part of the specification. The illustrated embodiments are merely examples of the present system and method and do not limit the scope thereof

FIG. 1 is a system block diagram illustrating the communication channels and sources of the present system and method, according to one exemplary embodiment;

FIG. 2 is an illustration of an exemplary electronic repository and cutter system web interface;

FIG. 3 is an illustration of an exemplary category sub menu of the web interface shown in FIG. 2;

FIG. 4 is an illustration of an exemplary pattern selection and customization interface;

FIG. 5 is an illustration of a representative pattern printer; and

FIG. 6 is a functional block diagram of an exemplary workstation consistent with the technology of the present application.

Throughout the drawings, identical reference numbers designate similar, but not necessarily identical, elements.

### DETAILED DESCRIPTION

Embodiments of the present exemplary system and method are described more fully below with reference to the accompanying figures, which form a part hereof and show, by way of illustration, specific exemplary embodiments. These embodiments are disclosed in sufficient detail to enable those skilled in the art to practice the exemplary system and method. However, embodiments may be implemented in many different forms and should not be construed as being limited to the embodiments set forth herein. The following detailed description is, therefore, not to be taken in a limiting sense.

The present specification describes a system that simplifies and streamlines the processes used by small-shop tailors and home seamstresses for making custom clothes. The traditional process of making clothes has changed little in the past 25 years. The traditional process is built on the foundation of a paper pattern, fabric stores with a limited inventory of fabrics, and labor intensive processes of cutting out and sewing materials.

According to the present exemplary system, the clothes or garment making process is based on a digital repository of patterns that are interactively adjusted for size. The patterns are downloadable and can be printed or transferred to an electronic cutter. Accordingly, this system simplifies the time and labor intensive processes of finding patterns, finding suitable material, and cutting out the material to match the pattern in the correctly adjusted size.

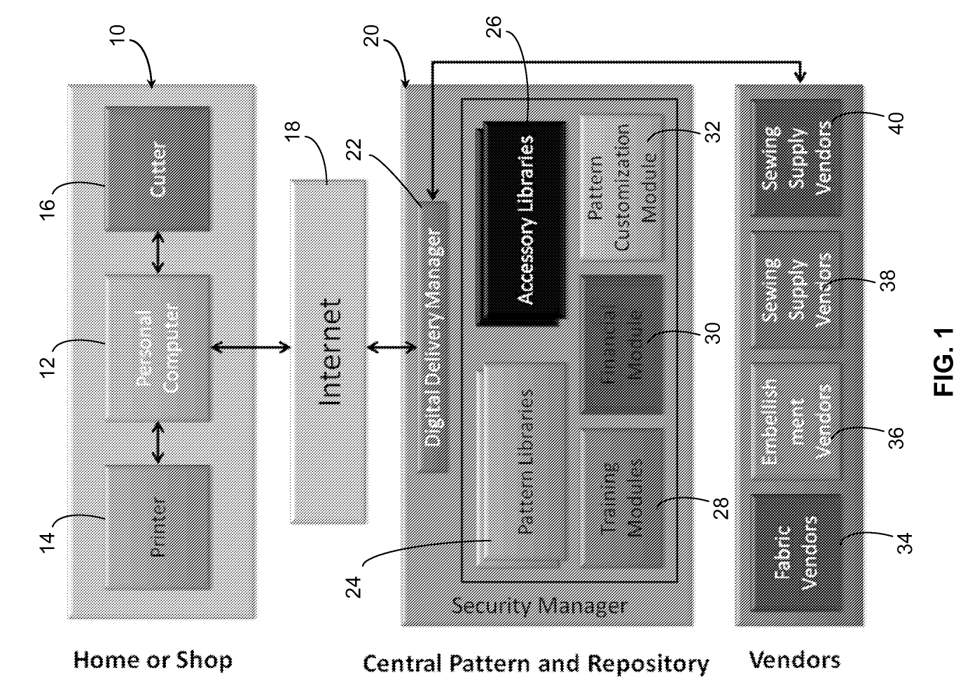

As shown in FIG. 1, the central website 20 includes a garment pattern file repository in the form of a plurality of pattern libraries 24. The central website 20, sometimes referred to as a Central Pattern and Sewing Repository (CPSR), allows individuals to search for a pattern from all pattern creators. The patterns are accessed and viewed by the user in a digital format, such as .dxf and .pdf, for example. Patterns are created by a variety of individuals and organizations. The digital representations of these patterns are uploaded to the central website's pattern libraries 24.

The central website 20 also includes accessory libraries 26 in which recommended buttons, zippers, trim, and fabric selections corresponding to the various patterns are stored. Pattern designers suggest the appropriate fabrics for production of a particular garment. The pattern designers are keenly aware that each fabric type used in a garment affects other aspects of making the garment including how the fabric is cut, the lining and tapes that must be used to reinforce the fabric type, the kind of needle that most cleanly pierces the fabric, the type of thread that will ensure the fabric will not be pulled, etc. These types of specifications and recommendations are uploaded to the accessory library 26 and are available to the customers.

Customers will be able to access a wide variety of fabrics and embellishes such as buttons, zippers, ribbons, sewing supplies, and equipment from vendors 34-40. The digital delivery manager 22 allows customers to shop for the various fabrics, embellishments, and supplies. For example, the fabric vendor 34 may supply the fabric recommended in the accessory library 26 for each pattern. Similarly, the embellishment vendors 36 can supply the recommended trim or lace. Sewing supply vendors 38 and 40 can supply the thread and lining materials.

The central website 20 also includes training modules 28, financial module 30, and the pattern customization module 32. The pattern customization module 32 allows a customer to select a pattern and input various parameters or variables by which the pattern customization module resizes the pattern accordingly. All patterns in the present exemplary CPSR system will be customizable based on a set of measurements and factors.

Pattern designers begin the process of designing a garment by sketching their pattern designs on paper and once there is consensus that the pattern parts will create the targeted design, the pattern pieces are created as a parametric model on a Computer-Aided Design (CAD) system or other digital drafting or design software (referred to herein generally as a CAD system). According to one exemplary embodiment, men's and women's fashions are typically created in a first instance in one size referred to as 40 regular, which in one example, includes a jacket with a 40-inch chest, a 32-33 inch sleeve length, and a pair of trousers with a 33-34 inch waist. Generally, in standard sizing for men's suits, the waist is 6 in less than the chest size of the jacket; thus, a 48 regular jacket would be accompanied by a pair of trousers with a 42-inch waist. All subsequent patterns are then scaled and/or adjusted from this standard 40 regular pattern. Specifications for printing or cutting patterns based on the input parameters is fed into the CAD system so that the pattern pieces are devised on a computer-generated system that produces all subsequent sizes of the 40 regular.

According to one exemplary embodiment, the patterns may be scaled by multiplying the dimensions of the 40 regular pattern by a percentage corresponding to the difference in size between the 40 regular and the size parameters input by the customer. The 40 regular pattern may also be adjusted by directly changing dimensions of the 40 regular. For example, the CAD model may be created with the exact inseam and waist dimensions input from the customer. It should be appreciate that the 40 regular pattern may be both scaled and adjusted for various height and girth inputs. Scaling and adjusting variables in parametric CAD models, is well known in the art.

A customer, or user, may access the central website 20 via the internet 18 by using their personal computer 12. It should be appreciated, that other devices may be used to access the central website 20, such as for example and without limitation, a tablet computer, a laptop computer, a desktop computer, a smart phone, or other personal computing device. The customer may have a printer 14 connected to computer 12, allowing them to print the pattern at home in the traditional manner. Alternatively, the user may print the pattern directly on a desired fabric. Furthermore, a customer may also have a cutter 16 connected to their personal computer 12 which would allow them to cut either a paper pattern or directly cut the pattern pieces from fabric according to the pattern downloaded. In another case, the customer could access the central website 20 from a retail outlet such as a fabric store. In this case, the retail outlet provides the computer connection (i.e. via wireless connection in the store) along with a cutter 16.

When the cutter is configured to cut fabric, rather than paper, the seamstress can, in a single step, cut the fabric for a customized garment. This approach shifts to the computer, much of the tedious modifications that had previously been made by the seamstress. The cutter accepts instructions from the computer that enable it to cut fabric based on a specific cutting layout. The cutter uses industry standard protocols and processes for numeric or command based machine control. In one example of a cutter, the cutter is able to cut fabric approximately 36 inches wide, and in order to keep the fabric in position the cutter comes with a specialized adhesive mat. The cutter is able to cut various thicknesses and densities of fabric. In some cases, this requires specialized blades for each type of fabric. Information about the fabric is transferred to the cutter as part of the instruction set generated by the computer. Suitable fabric cutters may include one or more blades (linear or rotary) or oscillating points that are selectively transported on one or more carriages as the fabric is systematically translated adjacent to the cutter.

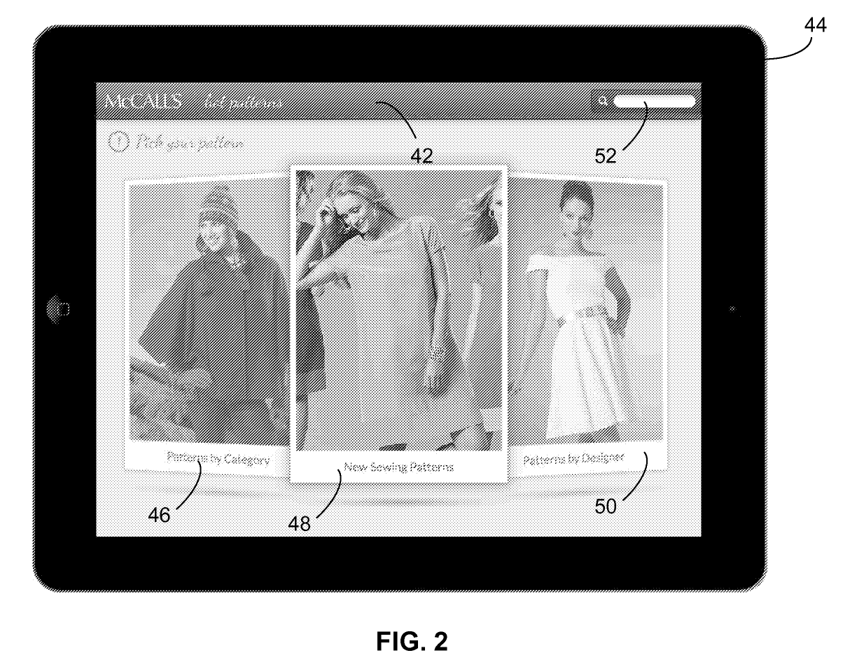

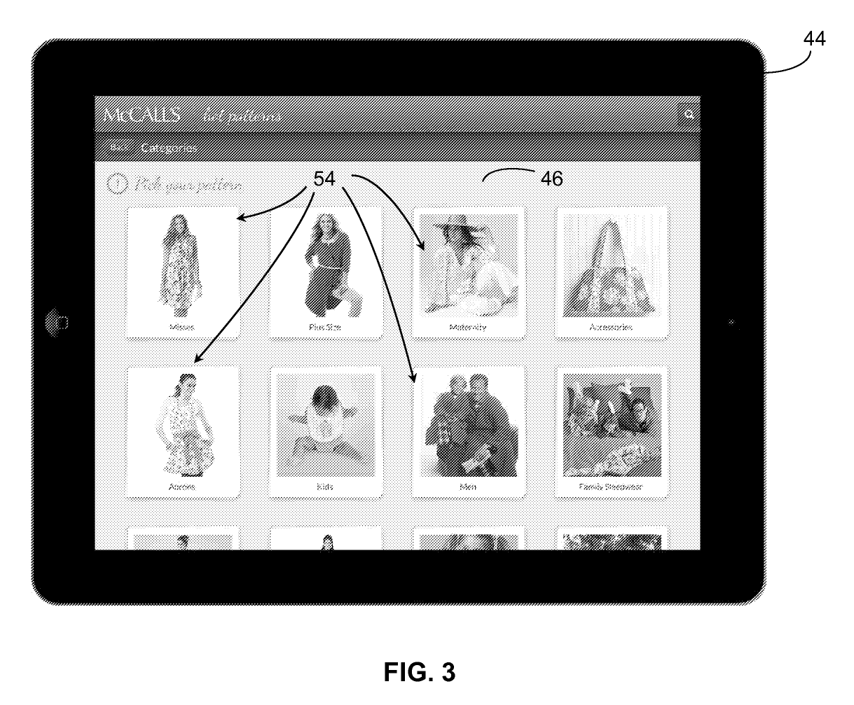

According to one exemplary embodiment, the central website 20 includes a web interface. An exemplary web interface 42 is shown in FIG. 2. The web interface 42, in this embodiment, includes a plurality of selection groups such as, in this case, patterns by category 46, new sewing patterns 48, and patterns by designers 50. A user may also search directly through search window 52 for specific pattern model numbers. As shown in FIG. 3, in this example, the patterns by category 46 has been selected which then displays a sub-menu of categories 54. For example, the categories in this case include misses, plus size, maternity, accessories, aprons, kids, men, etc. The web interface 42 may be accessed via a computer, tablet, or smart phone device. In this case, it is contemplated that the web interface 42 is accessed by an iPad® tablet device 44.

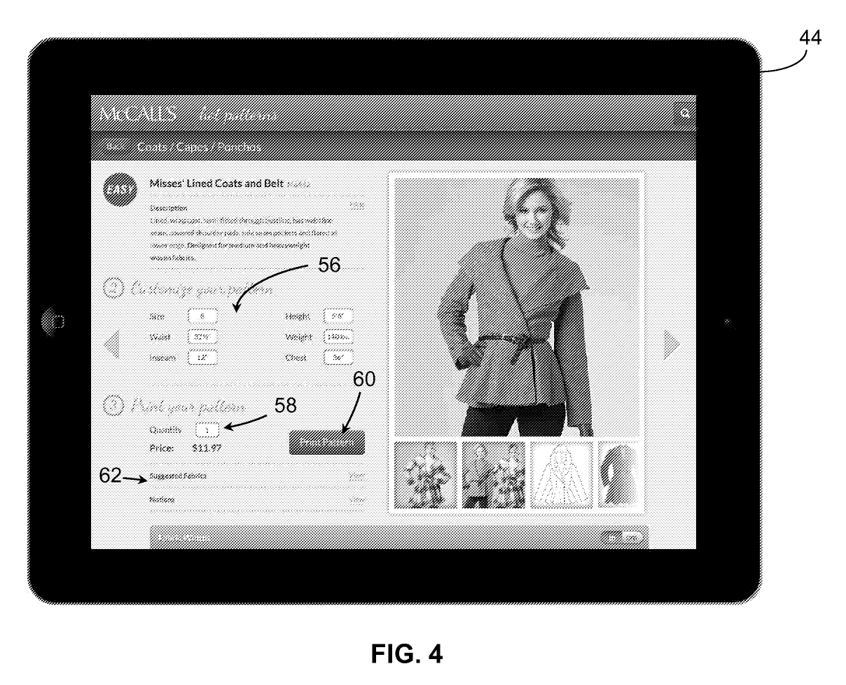

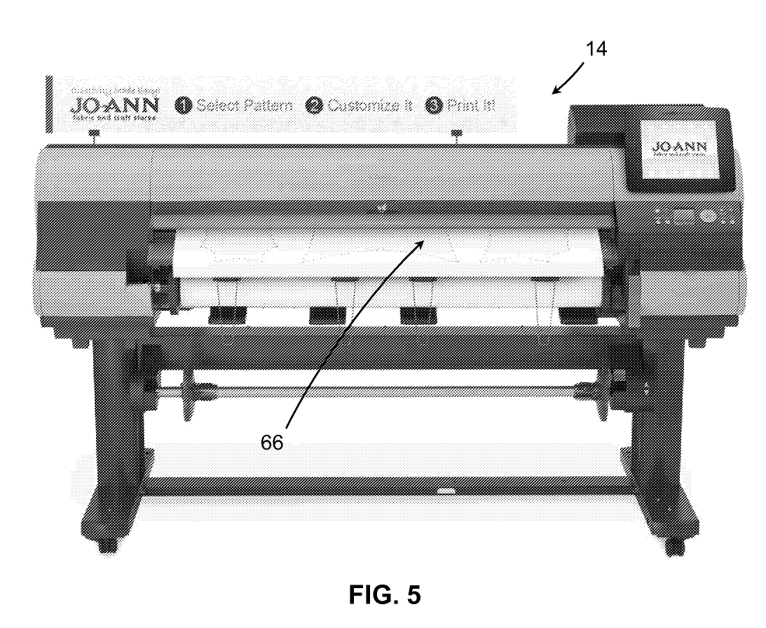

For each pattern, the interface displays an image of the pattern when it is completed, digital format of the pattern, a printable image of the pattern, and/or financial information about the pattern, such as price. Once a particular pattern is selected as shown in FIG. 4, the customer may customize their pattern by inputting various parameters 56. These parameters may include, for example and without limitation, size, waist, inseam, height, weight, chest, and the like. As mentioned above, the pattern customization module 32 uses these parameters to adjust and/or scale the pattern to fit the customer. Once the variables 56 have been input, and the pattern customization module 32 has adjusted the pattern size, the user may, in this case, select to print the pattern by pushing the Print Pattern button 60. The user also has the option to select the quantity of patterns printed in field 58. In the case of a retail outlet, and with reference to FIG. 5, the retail outlet may include a printer 64 to print patterns 66. In this exemplary embodiment, the printer 64 is a 36-inch wide plotter as is known in the art. However, any size printer/cutter may be utilized by the present exemplary system and method. Suitable plotters/printers are available from many manufacturers, such as Canon. It should be appreciated that a cutter 16 may be connected as well, and a suitable button may be provided on the web interface such that the customer has an option between cutting the material directly or printing the pattern and cutting it out later.

The CPSR system significantly simplifies and standardizes the process of acquiring patterns, material, and equipment. This is accomplished by centralizing and standardizing all purchases and delivery of digital content in one website system. There is a single standard digital content delivery format and mechanism based on current industry standards and approaches. Purchases are processed using a single standard purchasing mechanism that is based on current industry standards and approaches. Users are charged for each customized pattern download. Alterations to a downloaded pattern are charged a percent of a full pattern. Patterns are protected using industry standard digital rights management. The pattern download in process are managed using industry standard protocols and approaches. All non-downloaded transactions are coordinated with the appropriate vendor. Vendors will be responsible for product fulfillment while Financial Processing is handled centrally with remittances to the appropriate vendors.

In this new system, the seamstress will have the ability to download and print a pattern that is already customized according to the desired size. In addition, they have the option of sending the pattern to an electronic cutter that is capable of cutting out the customized pattern in either paper or fabric. If this option is selected, the computer becomes central in the process of laying out the fabric for the electronic cutter. The seamstress provides the computer with information about the fabric such as the dimensions, pattern, colors, and grain. The computer takes this information along with the customized pattern and creates an optimized layout for the electronic cutter. In addition, the computer makes any necessary data file conversions needed to support the formats of the electronic cutter.

According to one exemplary embodiment, the CPSR is configured as an application on a mobile tablet or phone and allows a user to design and customize a pattern according to their own specifications. Once customized the print pattern button 60 or an alternative cut fabric button (not shown) may be selected and data representative of the modified pattern and/or a selected material is then transmitted to a vendor 34, 36, 38, 40 for processing.

According to one exemplary embodiment, there is a storage scheme on the local computer for customized patterns. Users will have the option to print or cut customized patterns. For patterns that will be cut, there will be interactive functionality to gather information from the user regarding fabric dimensions, patterns, colors and grain. An application takes information about the fabrics, as well as, the dimensions of the customized pattern, and generates optimized cutting instructions for the electronic cutter. Cutting instructions are adapted to meet the input requirements of the electronic cutter. The system also has the ability to allow customers to make their own patterns. The customer can select various sleeves, cuffs, collars, bodies, and treatments from a component data base library, in order to create their own shirt, dress, and pants in their own size.

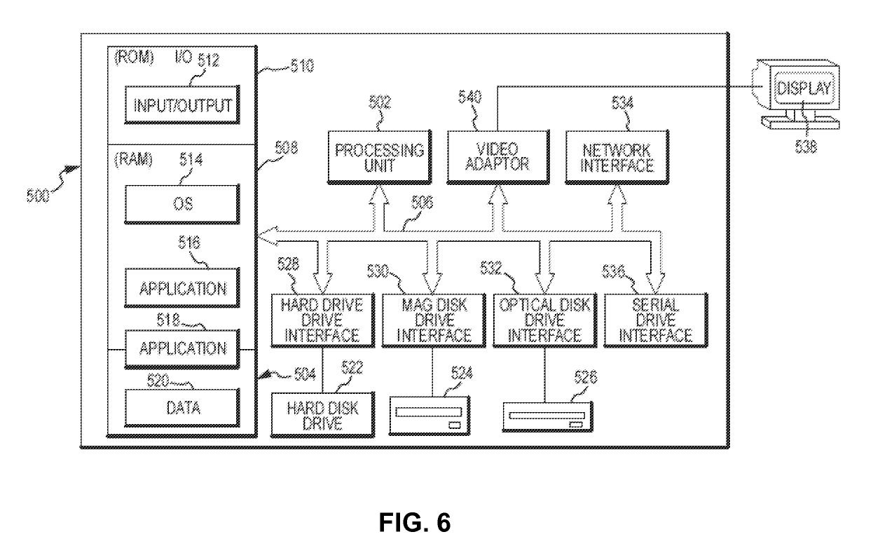

Referring now to FIG. 6, a functional block diagram of a typical workstation 500 for the technology of the present application is provided. Workstation 500 may be any of the above described personal computing devices, servers, or the like. The workstation 500 is shown as a single, contained unit, such as, for example, a desktop, laptop, tablet, handheld, smart phone, personal digital assistant, or mobile processor, but the workstation 500 may comprise portions that are remote and connectable via a network connection such as via a LAN, a WAN, a WLAN, a WiFi Network, Internet, or the like. Generally, the workstation 500 includes a processor 502, a system memory 504, and a system bus 506. The system bus 506, which may follow any conventional protocol such as, for example, PCI or PCI-express, couples the various system components and allows data and control signals to be exchanged between the components. The system memory 504 generally comprises both a random access memory (RAM) 508 and a read only memory (ROM) 510. The ROM 510 generally stores a basic operating information system such as a basic input/output system (BIOS) 512. The RAM 508 often contains the basic operating system (OS) 514, application software 516 and 518, and data 520. The system memory 504 (non-transitory computer readable medium) contains the code for executing the functions and processing the data as described herein to allow the present technology of the present application to function as described. The workstation 500 generally includes one or more of a hard disk drive 522 (which also includes flash drives, solid state drives, etc. as well as other volatile and non-volatile memory configurations), a magnetic disk drive 524, or an optical disk drive 526. The drives are connected to the bus 506 via a hard disk drive interface 528, a magnetic disk drive interface 530 and an optical disk drive interface 532. Application modules and data may be stored on a disk, such as, for example, a hard disk installed in the hard disk drive (not shown). The workstation 500 has network connection 534 to connect to a local area network (LAN), a wireless network, an Ethernet, the Internet, or the like, as well as one or more serial port interfaces 536 to connect to peripherals, such as a mouse, keyboard, microphone, touch screen, light pen, modem, or printer. The workstation 500 also may have USB ports or wireless components not shown. Workstation 500 typically has a display or monitor 538 connected to bus 506 through an appropriate interface, such as a video adapter 540. Monitor 538 may be used as an input mechanism using a touch screen, a light pen, or the like. On reading this disclosure, those of skill in the art will recognize that many of the components discussed as separate units may be combined into one unit and an individual unit may be split into several different units. Further, the various functions could be contained in one personal computer or spread over several networked personal computers and/or devices. The identified components may be upgraded and replaced as associated technology improves and advances are made in computing technology.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. The above identified components and modules may be superseded by new technologies as advancements to computer technology continue.

The various illustrative logical blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Accordingly, the electronic pattern repository and cutter system and methods have been described with some degree of particularity directed to the exemplary embodiments. It should be appreciated, however, that the present invention is defined by the following claims construed in light of the prior art so that modifications or changes may be made to the exemplary embodiments without departing from the inventive concepts contained herein.

What is claimed is:

1. A method for storing and accessing a garment pattern, comprising:
uploading digital representations of one or more garment patterns to a network accessible file repository;
accessing said file repository via a network connection associated with a personal computing device to download said digital representation of said one or more garment patterns;
communicating said digital representation of said one or more garment patterns from said personal computing device to a cutter; and
wherein said cutter accesses said one or more garment patterns to cut a portion of material according to said one or more garment patterns.

2. The method according to claim 1, wherein said cutter is configured to cut paper and further comprising cutting said paper to form a garment pattern.

3. The method according to claim 2, further comprising attaching said garment pattern to fabric and cutting said fabric along a perimeter of said garment pattern.

4. The method according to claim 1, wherein said cutter is configured to cut fabric and further comprising cutting said fabric to form portions of a garment corresponding with the one or more garment patterns.

5. The method according to claim 4, further comprising assembly said garment by joining said portions together.

6. The method according to claim 1, further comprising entering parameters describing the size of a garment.

7. The method according to claim 6, wherein said parameters are selected from the group consisting of size, waist, inseam, height, weight, and chest.

8. The method according to claim 6, further comprising scaling said one or more garment patterns based on said parameters.

9. The method according to claim 6, further comprising adjusting said one or more garment patterns based on said parameters.

10. A garment pattern repository and cutter system, comprising:
a garment pattern file repository stored on a network server;
a web interface associated with said garment pattern file repository;
a personal computing device interconnected with said server to facilitate interaction with said garment pattern file repository via said web interface; and
a cutter interconnected with the personal computing device, wherein said cutter is operative to cut a portion of material according to a garment pattern selected from said garment pattern repository.

11. The system according to claim 10, wherein said personal computing device is selected from the group consisting of a tablet computer, a laptop computer, a desktop computer, and a smart phone.

12. The system according to claim 10, wherein said web interface is stored on said network server.

13. The system according to claim 10, wherein said personal computing device is interconnected with said server via the internet.

14. The system according to claim 10, wherein said cutter is configured to cut paper into said garment pattern.

15. The system according to claim 10, wherein said cutter is configured to cut fabric into portions of a garment corresponding to said garment pattern.

16. The system according to claim 10, further comprising a pattern customization module operative to adjust the size of said garment pattern based on parameters received from said personal computing device.

17. A garment pattern repository and cutter system, comprising:
a garment pattern file repository stored on a network server;
a web interface associated with said garment pattern file repository;
a personal computing device interconnected with said server via the internet, said personal computing device operative to facilitate interaction with said garment pattern file repository via said web interface;
a cutter interconnected with the personal computing device, wherein said cutter is operative to cut fabric into portions of a garment corresponding to a garment pattern selected from said garment pattern repository; and
a pattern customization module operative to adjust the size of said garment pattern based on parameters received from said personal computing device.

18. The system according to claim 17, wherein said parameters are selected from the group consisting of size, waist, inseam, height, weight, and chest.

19. The system according to claim 17, wherein said personal computing device is selected from the group consisting of a tablet computer, a laptop computer, a desktop computer, and a smart phone.

20. The system according to claim 17, wherein said pattern customization module is operative to scale the size of said garment pattern based on said parameters.
